(19) United States
(12) Patent Application Publication
(10) Pub. No.: US 2019/0180532 A1
(43) Pub. Date: Jun. 13, 2019

(54) Systems And Methods For Calculating Reaction Time

(71) Applicant: Ford Global Technologies, LLC, Dearborn, MI (US)

(72) Inventor: Andre Aaron Melson, Fremont, CA (US)

(21) Appl. No.: 15/836,568

(22) Filed: Dec. 8, 2017

(51) Int. Cl. G07C 7/00; G07C 5/02; G06K 9/00

(52) U.S. Cl. CPC G07C 7/00; G06K 9/00825; G07C 5/02

(57) ABSTRACT

Example systems and methods for calculating driver reaction times are described. In one implementation, a method receives image data from a vehicle camera and identifies a light tree in the image data. A light activation sequence of the light tree is monitored based on the image data. The method detects movement of the vehicle and calculates a reaction time based on an elapsed time between activation of a last light in the light tree and movement of the vehicle.

### TECHNICAL FIELD

The present disclosure relates to vehicular systems and, more particularly, to systems and methods that calculate a driver reaction time associated with a vehicle.

### BACKGROUND

Vehicle racing, such as drag racing, is enjoyed by people in many parts of the world. When vehicles are drag racing at a race track, a light tree (commonly referred to as a “Christmas Tree” or “staging lights”) indicates the start of a race to the drivers of the vehicles. A driver's reaction time at the start of the drag race is important to the overall race results. For example, the faster a driver responds to a race starting light (without responding too early) the better race time the driver will receive.

In existing situations, a drag racing track typically measures driver reaction times using the light tree and photocells located near the track surface that are interrupted by the front tires of the vehicle. In these situations, the driver reaction time is provided to each driver after the race in the form of a printed track slip.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram illustrating an embodiment of a vehicle control system that includes a reaction time management system.

FIG. 2 is a block diagram illustrating an embodiment of a reaction time management system.

FIG. 3 illustrates an embodiment of an environment in which two vehicles are racing at a drag racing track.

FIG. 4 illustrates an embodiment of a light tree.

FIG. 5 is a flow diagram illustrating an embodiment of a method for staging vehicles and operating a light tree.

FIGS. 6A-6G illustrate an embodiment of a light activation sequence for a light tree.

FIGS. 7A-7B represent a flow diagram that illustrates an embodiment of a method for calculating a driver's reaction time.

### DETAILED DESCRIPTION

In the following disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter is described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed herein may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure are directed to computer program products comprising such logic (e.g., in the form of software) stored on any computer useable medium. Such software, when executed in one or more data processing devices, causes a device to operate as described herein.

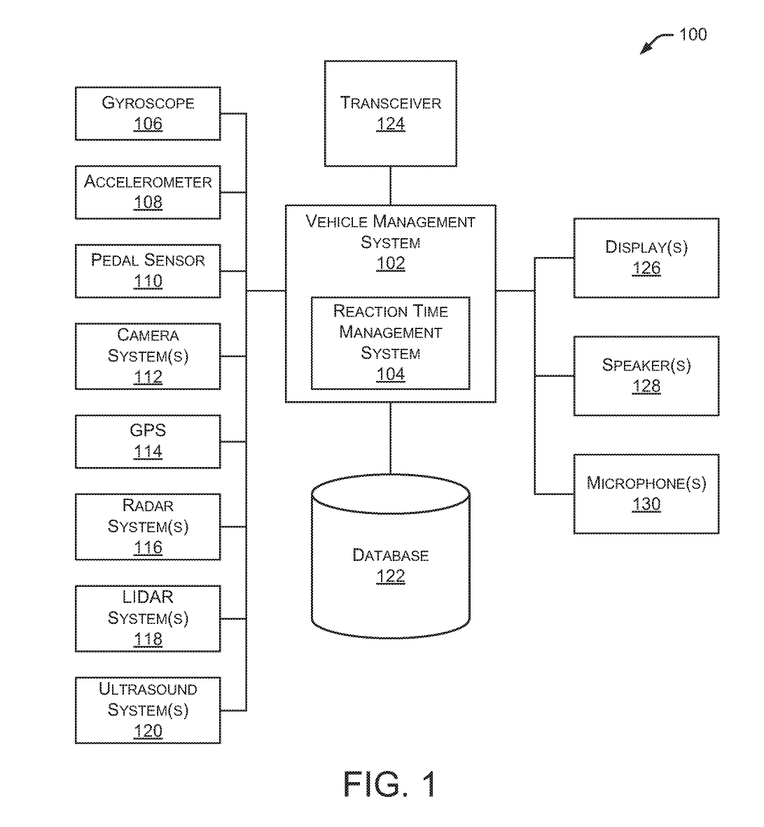

FIG. 1 is a block diagram illustrating an embodiment of a vehicle control system 100 that includes a reaction time management system 104. A vehicle management system 102 may be used to manage or control operation of various functions or features of a vehicle. For example, vehicle management system 102 may control one or more of braking, steering, seat belt tension, acceleration, lights, alerts, driver notifications, radio, vehicle locks, vehicle sensors, vehicle cameras, or any other systems, including auxiliary systems, of the vehicle. In another example, vehicle management system 102 may provide notifications and alerts to assist a human driver with various driving activities.

Vehicle control system 100 includes reaction time management system 104 that interacts with various components in the vehicle to calculate driver reaction times when drag racing the vehicle and communicating the driver reaction times to various systems, devices, and components as discussed herein. Although reaction time management system 104 is shown as being incorporated into vehicle management system 102 in FIG. 1, in alternate embodiments, reaction time management system 104 may be a separate component or may be incorporated into any other vehicle component.

Vehicle control system 100 also includes one or more sensor systems/devices for detecting a presence of nearby objects (or obstacles), detecting drag racing light trees, detecting lights on a light tree, and the like. In the example of FIG. 1, vehicle control system 100 may include one or more gyroscopes 106, accelerometers 108, pedal sensors 110, cameras 112, a global positioning system (GPS) 114, radar (radio detection and ranging systems) 116, Lidar (Light detection and ranging) systems 118, and/or ultrasound systems 120. In some embodiments, one or more gyroscopes 106 or accelerometers 108 may detect vehicle movement, vehicle orientation, and the like. Pedal sensor 110 may sense activation (or deactivation) of an accelerator pedal, a brake pedal, or a clutch pedal. Activation or deactivation of an accelerator, brake, or clutch pedal may indicate movement of the vehicle. In some embodiments, one or more cameras 112 may include a front-facing camera mounted to the vehicle (or incorporated into the vehicle structure) and configured to capture images of an area in front of a vehicle. GPS 114 provides information associated with the geographic location of the vehicle. Radar systems 116, Lidar systems 118, and ultrasound systems 120 provide information related to object in the vicinity of the vehicle. In some embodiments, vehicle control system 100 may also include a wheel speed sensor coupled to vehicle management system 102. The wheel speed sensor is capable of detecting movement of a wheel of the vehicle.

Vehicle control system 100 may include a database 122 for storing relevant or useful data related to controlling any number of vehicle systems, or other data. Vehicle control system 100 may also include a transceiver 124 for wireless communication with a mobile or wireless network, other vehicles, infrastructure, or any other communication system. In some embodiments, vehicle control system 100 may also include one or more displays 126, speakers 128, microphones 126, or other devices so that notifications to a human driver or passenger may be provided. Display 126 may include a heads-up display, dashboard display or indicator, a display screen, or any other visual indicator, which may be seen by a driver or passenger of a vehicle. Speaker 124 may include one or more speakers of a sound system of a vehicle or may include a speaker dedicated to driver or passenger notification. One or more microphones 130 may include any type of microphone located inside or outside the vehicle to capture sounds originating from inside or outside the vehicle.

It will be appreciated that the embodiment of FIG. 1 is given by way of example only. Other embodiments may include fewer or additional components without departing from the scope of the disclosure. Additionally, illustrated components may be combined or included within other components without limitation.

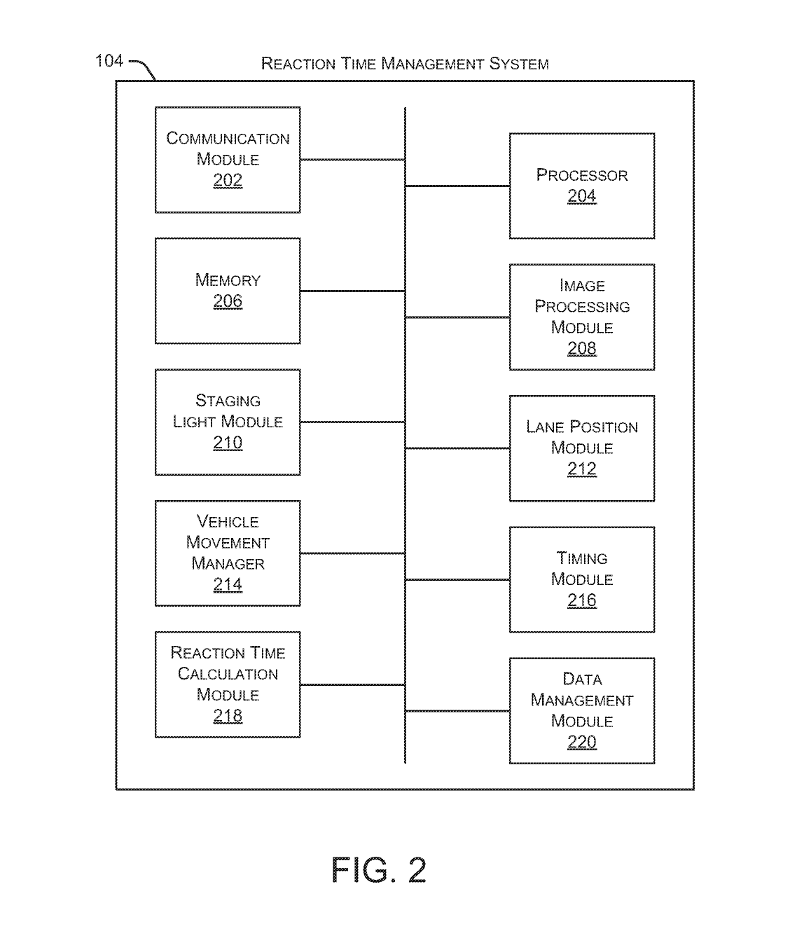

FIG. 2 is a block diagram illustrating an embodiment of reaction time management system 104. As shown in FIG. 2, reaction time management system 104 includes a communication module 202, a processor 204, and a memory 206. Communication module 202 allows reaction time management system 104 to communicate with other systems, such as vehicle management system 102, components 106-120, and communicate with other users and systems external to the vehicle.

Processor 204 executes various instructions to implement the functionality provided by reaction time management system 104, as discussed herein. Memory 206 stores these instructions as well as other data used by processor 204 and other modules and components contained in reaction time management system 104.

Additionally, reaction time management system 104 includes an image processing module 208 that is capable of receiving image data (e.g., from camera 112) and identifying objects, such as a light tree and lights activated by the light tree, contained in the image data. A staging light module 210 identifies the status of a light tree (or a staging light) based on received image data and analysis by image processing module 208. A lane position module 212 determines the lane of a drag strip in which a vehicle is located (e.g., the left lane or the right lane). In some embodiments, this determination is based on an analysis of the image data. For example, if the light tree is located to the right of the vehicle, then the vehicle is in the left lane. Similarly, if the light tree is located to the left of the vehicle, then the vehicle is in the right lane.

Reaction time management system 104 also includes a vehicle movement manager 214 that detects movement of the vehicle. In some embodiments, vehicle movement may be detected based on data received from one or more vehicle sensors. For example, movement is detected if the accelerator pedal is activated (identified by pedal sensor 110) or accelerometer 108 detects movement of the vehicle. In other embodiments, any vehicle sensor or other system may be used to detect movement of the vehicle.

A timing module 216 monitors the timing lights in a light tree and determines when the last light is activated by the light tree. The time associated with activation of the last light in the light tree is used by reaction time calculation module 218 to calculate the vehicle driver's reaction time, as discussed herein. A data management module 220 collects and manages data from various vehicle sensors, systems, and components. Data management module 220 also collects and manages data from other systems, including systems external to the vehicle. This data from other systems includes, for example, outside temperature data at the race track, elevation of the race track, weather conditions, the like. In some embodiments, data management module 220 further collects and manages data related to the driver identity, vehicle identity, date, time of day, which lane a vehicle is located in, and the like. The data collected and managed by data management module 220 may be used for generating notifications, generating reports, storing data, communicating data to other systems, and the like.

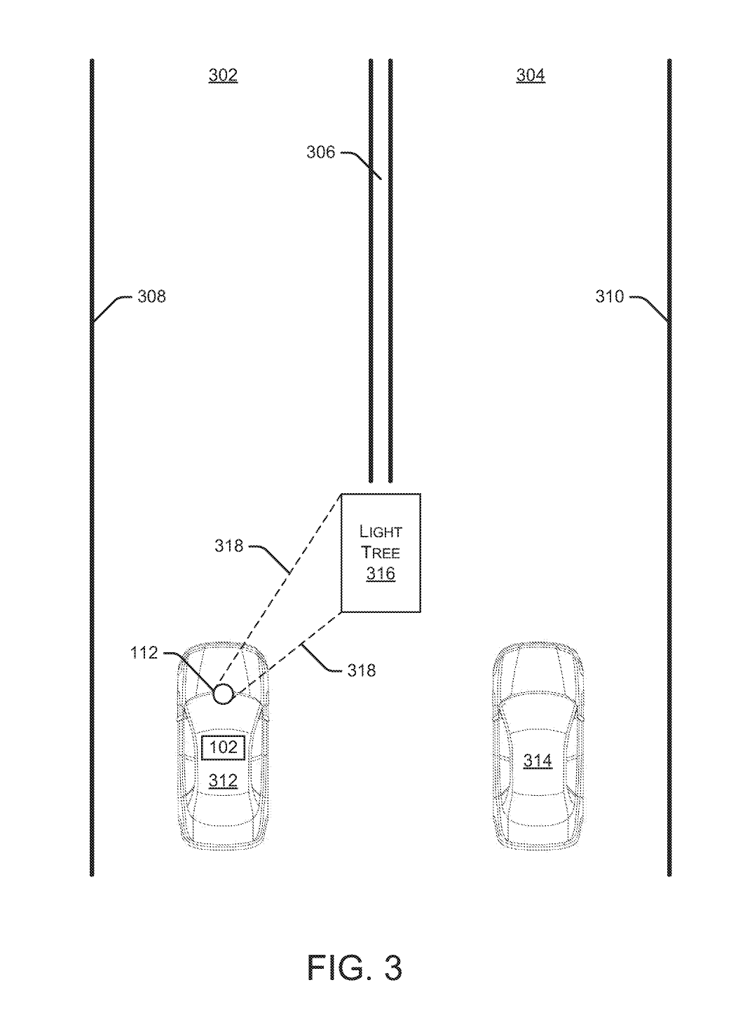

FIG. 3 illustrates an embodiment of an environment in which two vehicles are racing at a drag racing track. The drag racing track has a left lane 302 and a right lane 304 with a center line 306 separating the two lanes. Left lane 302 has a left lane line 308 and right lane 304 has a right lane line 310. A first vehicle 312 is driving in left lane 302 and a second vehicle 314 is driving in right lane 304. As shown in FIG. 3, first vehicle 312 includes vehicle management system 102 (which includes reaction time management system 104), as discussed herein. Additionally, first vehicle 312 includes at least one camera 112 that is capable of viewing a light tree 316. As illustrated in FIG. 3, light tree 316 is located between left lane 302 and right lane 304. Light tree 316 may also be referred to as an electronic starting system, electronic starting device, a Christmas Tree, a staging light, or a staging system. As discussed herein, light tree 316 includes multiple lights that communicate vehicle staging information and race start information to the drivers of vehicles 312 and 314.

Camera 112 in first vehicle 312 captures image data associated with light tree 316 as indicated by broken lines 318. In some embodiments, second vehicle 314 includes vehicle management system 102 and camera 112 of the type discussed herein. In other embodiments, second vehicle 314 does not include vehicle management system 102 or camera 112. Thus, the vehicle management system 102, reaction time management system, and camera 112 in first vehicle 312 may operate independently of any other vehicle operating on the drag racing track.

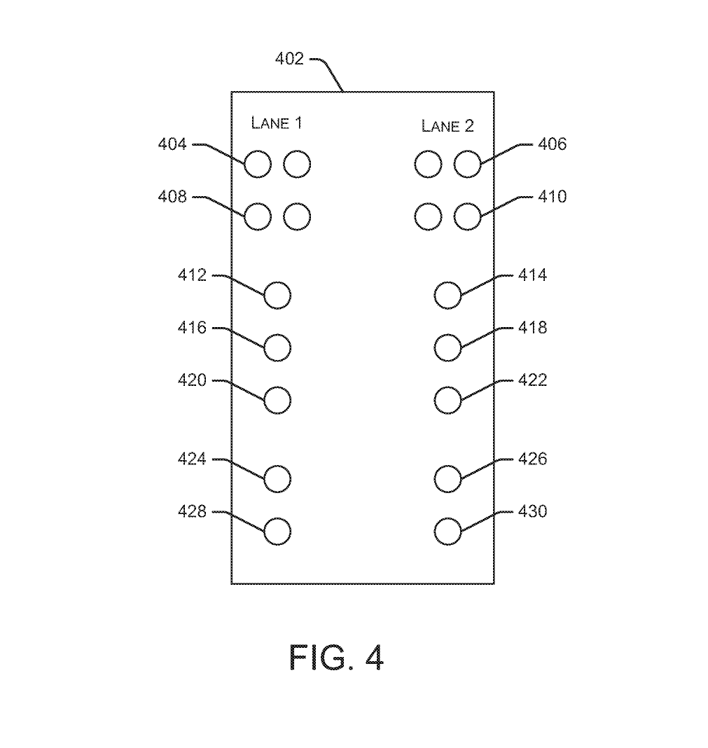

FIG. 4 illustrates an embodiment of a light tree 402, which has a left column of lights associated with the vehicle in lane 1 (i.e., the left lane) and a right column of lights associated with the vehicle in lane 2 (i.e., the right lane). Lights 404 indicate that the vehicle in lane 1 has pre-staged and lights 406 indicate that the vehicle in lane 2 has pre-staged. Pre-staging means the vehicle is very close to the starting line. Lights 408 indicate that the vehicle in lane 1 has staged and lights 410 indicate that the vehicle in lane 2 has staged. When a vehicle is “staged,” it indicates that the vehicle is at the starting line and ready for the race to begin.

A series of three countdown lights 412, 416, and 420 associated with lane 1 are activated to instruct the driver of the vehicle in lane 1 that the drag race is about to start. After the third countdown light 420 is activated, a green light 424 is activated 0.5 seconds later. Thus, after the third countdown light 420 is activated, the driver should be ready to start the car down the track in 0.5 seconds (i.e., as soon as green light 424 is activated). If the driver in lane 1 leaves the starting line too early, a red light 428 is activated instead of green light 424.

Similarly, for lane 2, a series of three countdown lights 414, 418, and 422 associated with lane 2 are activated to instruct the driver of the vehicle in lane 2 that the drag race is about to start. After the third countdown light 422 is activated, a green light 426 is activated 0.5 seconds later. Thus, after the third countdown light 422 is activated, the driver in lane 2 should be ready to start the car down the track in 0.5 seconds (i.e., as soon as green light 426 is activated). If the driver in lane 2 leaves the starting line too early, a red light 430 is activated instead of green light 426. In some embodiments, lights 404-422 are yellow, lights 424 and 426 are green, and lights 428 and 430 are red. In other embodiments, any combination of colors may be used for the lights in light tree 402.

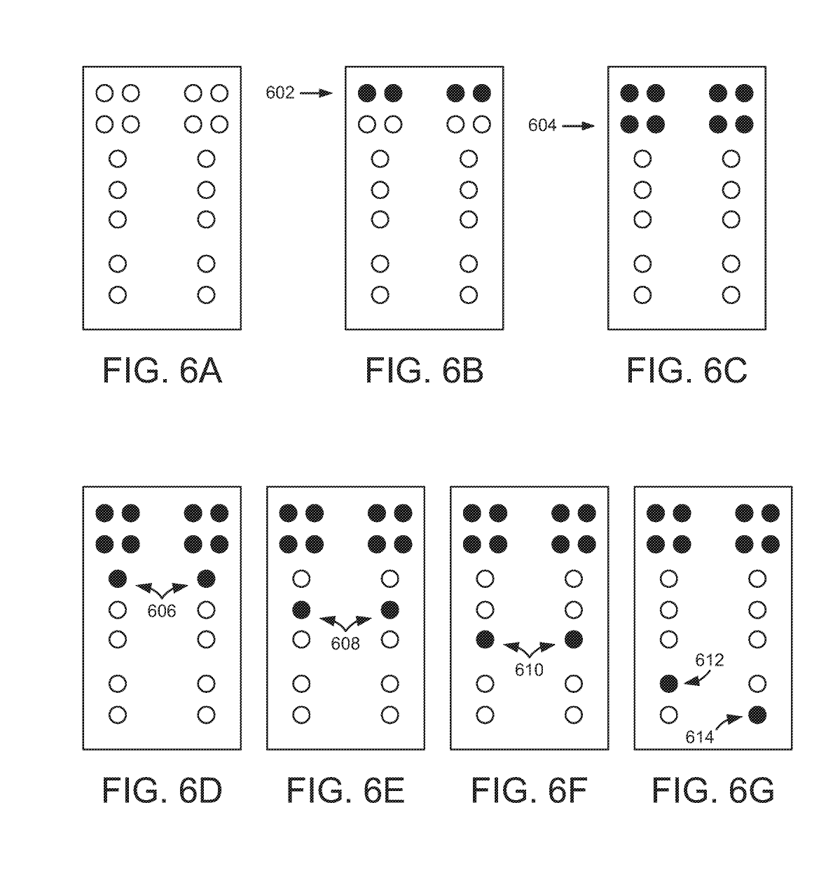

The timing of the light sequence of light tree 402 is described for a “full” light tree (also referred to as a “normal” tree or a “sportsman” tree). In other embodiments, a “pro” or “professional” light tree has different light sequencing procedures. For example, with a pro light tree, the delay between activation of the last countdown light and activation of the green light is 0.4 seconds. Additionally, pro light trees typically activate all three countdown lights simultaneously. Additional details regarding the sequencing of light tree 402 are discussed herein with respect to FIGS. 6A-6G.

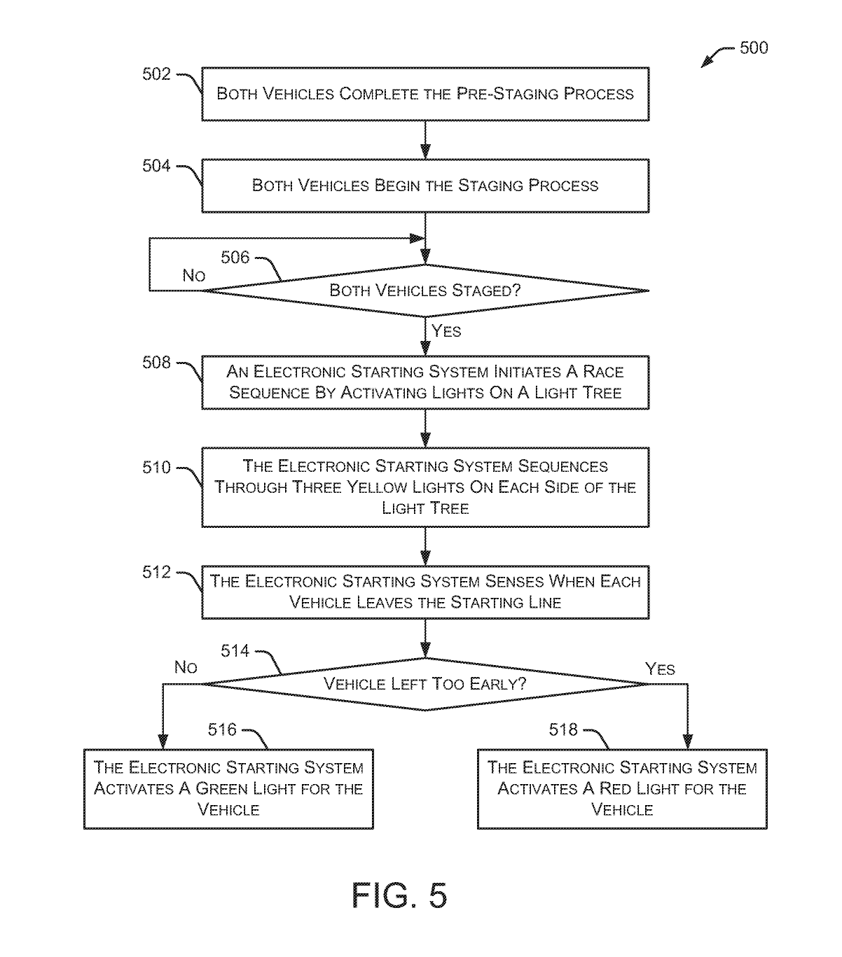

FIG. 5 is a flow diagram illustrating an embodiment of a method 500 for staging vehicles and operating a light tree. Initially, both vehicles complete 502 the pre-staging process by moving close to the starting line. Both vehicles then begin 504 the staging process by moving closer to the starting line. Both vehicles are monitored 506 until they are both staged (i.e., stopped at the starting line). When both vehicles are staged 506, an electronic starting system initiates 508 a race sequence (also referred to as a countdown sequence) by sequentially activating the countdown lights on a light tree. For example, as discussed above with respect to FIG. 4, the countdown lights may include lights 412, 416, and 420 for the left lane, and lights 414, 418, and 422 for the right lane.

The electronic starting system sequences 510 through the three yellow lights (i.e., countdown lights) on each side of the light tree. The electronic starting system senses 512 when each vehicle leaves the starting line. In traditional systems, a light beam and photocell located near the track surface detect interruption of the light beam by the front tires of the vehicle to indicate a tire position (and tire movement) at the starting line. If a vehicle leaves the starting line before the green light is activated, the driver of the vehicle is disqualified because they left the starting line too early. This is commonly referred to as a “red light” or “fault.” If, at 514, the vehicle leaves the starting line too early, the electronic starting system activates 518 a red light for the vehicle. However, if the vehicle does not leave too early, at 514, the electronic starting system activates 516 a green light for the vehicle.

FIGS. 6A-6G illustrate an embodiment of a light activation sequence for a light tree. In FIGS. 6A-6G, the filled circles represent activated lights (i.e., lights that are turned on) and empty circles represent deactivated lights (i.e., lights that are turned off). In this example, two vehicles are drag racing—a first vehicle in the left lane and a second vehicle in the right lane. FIG. 6A represents the status of the light tree before either vehicle has approached the starting line. In FIG. 6B, pre-staging lights 602 for both vehicles are activated, indicating that both vehicles are very close to the starting line. In FIG. 6C, staging lights 604 are activated for both vehicles, indicating that both vehicles are at the starting line and ready to race.

FIG. 6D illustrates the light tree after the first pair of countdown lights 606 are activated. As discussed above, a particular light tree may include a series of countdown lights that are activated sequentially prior to the start of the race (i.e., before the green light is activated, which indicates the start of the race). In FIG. 6E, the first pair of countdown lights 606 are deactivated and a second pair of countdown lights 608 are activated. Continuing to FIG. 6F, the second pair of countdown lights 608 are deactivated and a third pair of countdown lights 610 are activated. FIG. 6G represents the light tree after the race has started. As shown in FIG. 6G, a green light 612 is activated for the vehicle in the left lane, indicating that the vehicle in the left lane started the race at the proper time. However, a red light 614 is activated for the vehicle in the right lane, indicating that the vehicle in the right lane started the race too early. In some embodiments, when one vehicle receives a green light and the other vehicle receives a red light, the vehicle with the green light automatically wins the race regardless of which vehicle crosses the finish line first.

The light activation sequence shown in FIGS. 6A-6G represents an embodiment when both vehicles start racing at the same time. In other embodiments, one vehicle may be allowed to start the race before the other vehicle (e.g., providing an advantage to a slower vehicle by letting the slower vehicle start first). The light tree shown in FIGS. 6A-6G (and light tree 402 shown in FIG. 4) have three countdown lights. Other light tree embodiments may include any number of countdown lights. Additionally, alternate embodiments of the light tree may contain fewer lights than those shown in FIGS. 6A-6G and 4, or may contain additional lights not shown in FIGS. 6A-6G and 4.

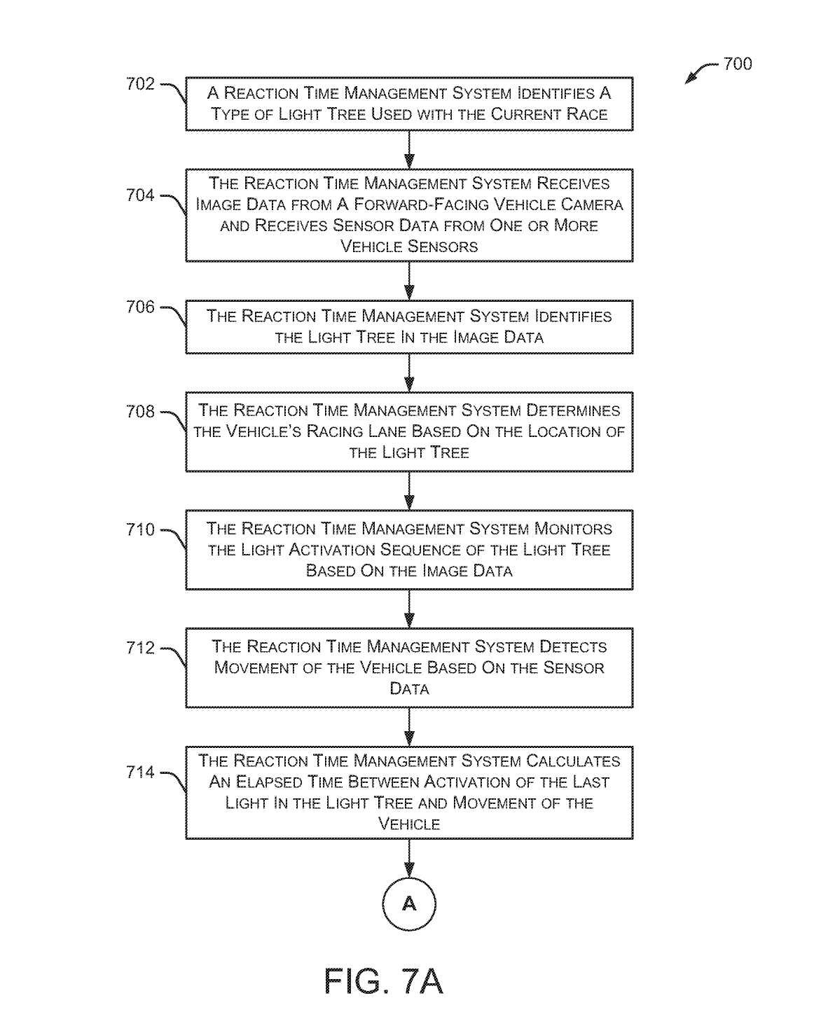

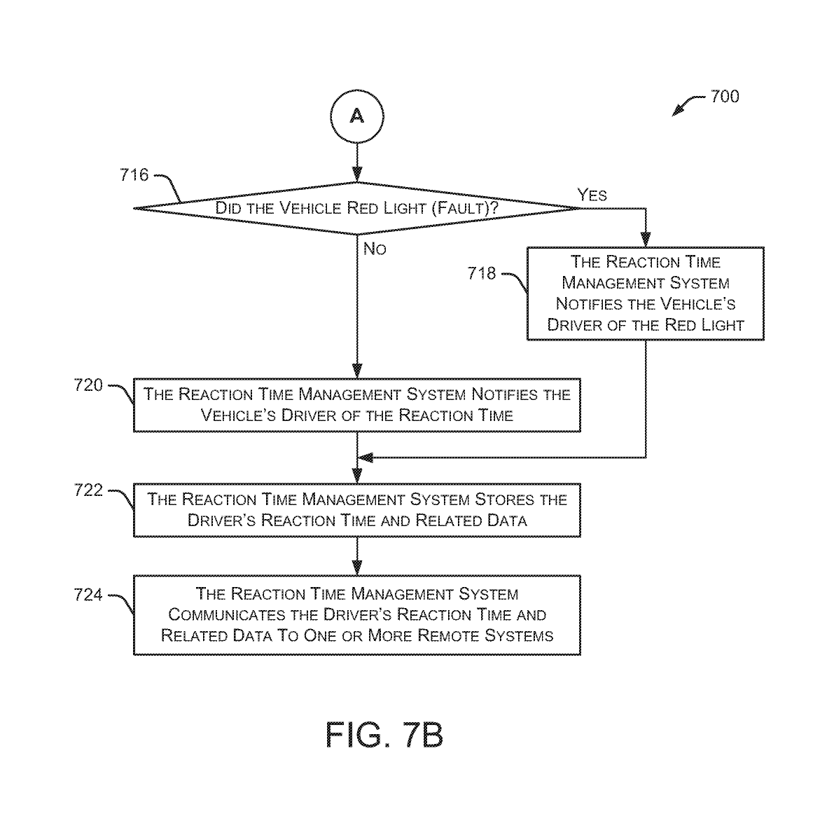

FIGS. 7A-7B represent a flow diagram that illustrates an embodiment of a method 700 for calculating a driver's reaction time. Initially, a reaction time management system identifies 702 a type of light tree used with the current race. In some embodiments, a driver of a vehicle identifies the type of light tree (e.g., a full light tree or a pro light tree). In some embodiments, if the type of light tree is not identified, method 700 defaults to the operating mode associated with a full light tree (also referred to as a normal tree or a sportsman tree). In some implementations, the type of light tree can be determined based on the sequencing of the countdown lights. For example, if the three countdown lights are activated sequentially, then the light tree is a full light tree. However if all three countdown lights are activated simultaneously, the light tree is a pro light tree.

At 704, the reaction time management system receives image data from a forward-facing vehicle camera (such as camera 112) and receives sensor data from one or more vehicle sensors (such as sensors and systems 106-110 and 114-120). Method 700 continues as the reaction time management system identifies 706 the light tree in the received image data. In some embodiments, an image recognition algorithm (or camera recognition algorithm) is used to identify the light tree in the image data. A similar algorithm may be used to identify the activation and deactivation of specific lights in the light tree. Example algorithms may include a convolutional neural network, a cascade classifier, a cascade classifier using AdaBoost (Adaptive Boosting), and the like. Those skilled in the art will appreciate that various algorithms may be used to identify the light tree and individual lights in the image data. The reaction time management system then determines 708 the vehicle's racing lane based on the location of the light tree as identified in the received image data. For example, if the light tree is located to the right of the vehicle, then the vehicle is in the left lane. Similarly, if the light tree is located to the left of the vehicle, then the vehicle is in the right lane.

Method 700 continues as the reaction time management system monitors 710 the light activation sequence of the light tree based on the image data. For example, if the vehicle is in the left lane, the reaction time management system monitors 710 the lights on the left side of the light tree. Similarly, if the vehicle is in the right lane, the reaction time management system monitors 710 the lights on the right side of the light tree. In some embodiments, monitoring 710 the light activation sequence of the light tree includes identifying the activation and/or deactivation of individual lights in the light tree. In particular implementations, monitoring 710 the light activation sequence of the light tree includes associating a time with each light activation and/or deactivation.

At 712, the reaction time management system detects movement of the vehicle based on the received sensor data. In some embodiments, vehicle movement is detected 712 based on activation of an accelerator pedal or movement detection by an accelerometer, gyroscope, or GPS system. In some situations, a radar, Lidar, or ultrasound system is used to detect movement of the vehicle. For example, a radar, Lidar, or ultrasound system may detect movement of a stationary object (such as a building) with respect to the vehicle, thereby indicating that the vehicle is moving. In some embodiments, vehicle movement can be detected using data from wheel speed sensors or similar wheel movement sensors. In particular implementations, detecting 712 movement of the vehicle includes associating a time with the movement detection.

After vehicle movement is detected 712, the reaction time management system calculates 714 an elapsed time between activation of the last light in the light tree (e.g., the last countdown light) and movement of the vehicle. As mentioned herein, the timing light automatically provides a 0.5 second delay between activation of the last countdown light and activation of the green light indicating the start of the race. Thus, if the vehicle begins moving less than 0.5 seconds after activation of the last countdown light, the vehicle left the starting line too early. However, if the vehicle begins moving 0.5 seconds or longer after activation of the last countdown light, the vehicle left the starting line at the proper time. The elapsed time between activation of the last countdown light and movement of the vehicle is referred to as the driver's “reaction time.” A perfect reaction time means the driver's vehicle left the starting line at the instant the green light was activated (i.e., a 0.5 (or 0.500) second reaction time). The larger the driver's reaction time, the greater the delay between activation of the green light and movement of the vehicle. It is advantageous for drivers to achieve a reaction time as close to 0.5 seconds as possible. In some embodiments, driver reaction times are represented to three decimal places, such as 0.512, 0.640, 1.008, and the like.

After calculating the driver's reaction time, method 700 determines, at 716, whether the vehicle left the starting line too early (i.e., a red light (or fault) situation). As discussed herein, this is determined based on the driver's reaction time. If the driver's reaction time is less than 0.5 seconds, the vehicle left the starting line too early and, at 718, the reaction time management system notifies the vehicle's driver of the red light (or fault) situation. However, if the driver's reaction time is greater than (or equal to) 0.5 seconds, the vehicle did not leave the starting line too early and, at 720, the reaction time management system notifies the driver of the reaction time. In some embodiments, the reaction time management system may wait until after the driver has crossed the finish line to provide the reaction time notification to the driver, thereby avoiding driver distraction during the race. In particular implementations, a driver may be notified immediately of the red light situation so they can choose to abort the race since they have already lost due to the red light. In some embodiments, communication module 202 communicates notifications to the driver and other users or systems.

In some embodiments, notifications to the driver are provided to a driver's smartphone, a vehicle infotainment system, and the like. In particular implementations, notifications can be communicated to the driver's preferred data management tool or online storage platform. Additionally, the reaction time management system stores 722 the driver's reaction time and related data for future reference. The related data may include, for example, driver identity, vehicle identity, date, time of day, which lane a vehicle is located in, outside temperature data at the race track, elevation of the race track, weather conditions, the like. In some embodiments, related data may also include vehicle settings, vehicle configurations, the type of tires (regular tires or slicks), type of fuel, and other modifications to the vehicle. This related data allows the driver (or other person or system) to analyze reaction times in different settings and different racing conditions to identify patterns and find ways to improve the driver's reaction times. In some embodiments, the driver's reaction time and related data are stored in database 122. Additionally, at 724, the reaction time management system communicates the driver's reaction time and related data to one or more remote systems. These remote systems include, for example, remote servers, remote data storage systems, cloud-based data management (or data analysis) systems, and the like.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments, but should be defined only in accordance with the following claims and their equivalents. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A method comprising:
receiving image data from a vehicle camera;
identifying, by a reaction time management system, a light tree in the image data;
monitoring, by the reaction time management system, a light activation sequence of the light tree based on the image data;
detecting movement of the vehicle; and
calculating a reaction time based on an elapsed time between activation of a last light in the light tree and movement of the vehicle.

2. The method of claim 1, further comprising:
determining, by the reaction time management system, a type of light tree in the image data; and
adjusting a formula used to calculate the reaction time based on the type of light tree used.

3. The method of claim 1, wherein the vehicle camera is forward-facing and mounted to vehicle.

4. The method of claim 1, further comprising receiving data from at least one vehicle sensor and wherein detecting movement of the vehicle is based on data received from the at least one vehicle sensor.

5. The method of claim 4, wherein the at least one vehicle sensor is one of an accelerometer, a vehicle pedal sensor, a global positioning system (GPS), a radar system, a lidar system, an ultrasound system, and a wheel speed sensor.

6. The method of claim 1, further comprising determining, by the reaction time management system, the vehicle's racing lane based on a location of the light tree in the image data.

7. The method of claim 1, further comprising storing the reaction time data.

8. The method of claim 7, further comprising collecting and associating other data with the reaction time data, wherein the other data includes at least one of a date, time of day, temperature, track conditions, track altitude, weather, lane position, vehicle identity, and driver identity.

9. The method of claim 1, further comprising communicating the reaction time to a driver of the vehicle.

10. The method of claim 1, further comprising communicating the reaction time to a remote system.

11. The method of claim 1, further comprising determining whether the vehicle red-lighted based on the calculated reaction time.

12. The method of claim 1, wherein the last light in the light tree is the last countdown light in the light tree.

13. The method of claim 1, wherein the reaction time is a reaction time of a driver of the vehicle.

14. An apparatus comprising:
an image processing module configured to receive data from a vehicle camera and identify a light tree in the image data;
a staging light module configured to monitor a light activation sequence of the light tree based on the image data;
a vehicle movement manager configured to detect movement of the vehicle; and
a reaction time calculation module configured to calculate a reaction time based on an elapsed time between activation of a last light in the light tree and movement of the vehicle.

15. The apparatus of claim 14, further comprising a lane position module configured to determine the vehicle's racing lane based on the image data.

16. The apparatus of claim 14, wherein the vehicle movement manager detects movement of the vehicle based on data received from a vehicle sensor.

17. The apparatus of claim 16, wherein the vehicle sensor includes one of an accelerometer, a vehicle pedal sensor, a global positioning system (GPS), a radar system, a lidar system, an ultrasound system, and a wheel speed sensor.

18. The apparatus of claim 14, further comprising a data management module configured to store the reaction time.

19. The apparatus of claim 18, wherein the data management module is further configured to collect and associate other data with the reaction time, wherein the other data includes at least one of a date, time of day, temperature, track conditions, track altitude, weather, lane position, vehicle identity, and driver identity.

20. The apparatus of claim 14, further comprising a communication module configured to communicate the reaction time to a driver of the vehicle.
